(19) United States
(12) Patent Application Publication
(10) Pub. No.: US 2025/0349287 A1
(43) Pub. Date: Nov. 13, 2025

(54) METHOD AND APPARATUS FOR UNDERSTANDING USER INTENT BY USING USER'S UTTERANCE FREQUENCY DATA

(71) Applicants: HYUNDAI MOTOR COMPANY, Seoul (KR); KIA CORPORATION, Seoul (KR)

(72) Inventor: Bo Hyun Kim, Hwaseong-si (KR)

(73) Assignees: HYUNDAI MOTOR COMPANY, Seoul (KR); KIA CORPORATION, Seoul (KR)

(21) Appl. No.: 18/821,540

(22) Filed: Aug. 30, 2024

(30) Foreign Application Priority Data
May 13, 2024 (KR) 10-2024-0062372

(51) Int. Cl. G10L 15/18; G10L 15/22

(52) U.S. Cl. CPC G10L 15/1815; G10L 15/22; G10L 2015/223

(57) ABSTRACT

A method and apparatus for understanding user intent by using user's utterance frequency data. An aspect of the present disclosure provides a method for understanding an utterance intent using utterance frequency data of a user, the method comprising: checking a screen ID of a previous screen before a user utterance is input; obtaining a number of utterances per screen ID from the utterance frequency data; obtaining a ratio of user utterances intended as a local command from the utterance frequency data when the number of utterances per screen ID is larger than or equal to a predetermined number for all screen ID; and adjusting a threshold of a confidence score based on the ratio.

### CROSS-REFERENCE TO RELATED APPLICATION

This application claims the benefit of and priority to Korean Patent Application No. 10-2024-0062372, filed on May 13, 2024, the entire contents of which are hereby incorporated herein by reference.

### TECHNICAL FIELD

The present disclosure relates to a method and apparatus for understanding a user's utterance intent using utterance frequency data of the user.

### BACKGROUND

The content described below simply provides background information related to the present disclosure and may not constitute prior art.

Dialogue systems that enable a conversation with a user using natural language, such as chatbots or virtual assistants, are now being adopted in various fields. For a dialog system to conduct a conversation with a user, the system should understand the user's utterance, or input message, from the dialog system's perspective. To achieve effective natural language understanding (NLU), the dialogue system may derive the current context from the conversation between the dialogue system and the user and the user's intent expected from the context and may analyze the input message based on the derived context and/or intent.

To provide a voice recognition service that achieves the goal above, an information provision device for providing information to a user should be capable of recognizing various utterances of the user and providing information based on the recognized utterances.

However, conventional voice recognition-based devices linked to vehicles have a problem in that they are not capable of accurately interpreting user utterances.

For example, when a user says “Yanghwa Bridge,” it is unclear whether the user's intent is to search for a point of interest (POI) or to search for a song. Inaccurate interpretation has often resulted in the conventional device's failing to provide the information desired by the user accurately.

Therefore, there is a need for a method to understand the user's utterance intent using the user's utterance frequency data.

### SUMMARY

An object of the present disclosure is to provide a method and an apparatus that understand a user's utterance intent using the utterance frequency data of the user. Specifically, an object of the present disclosure is to determine the proportion of cases in which a user's utterance intent is a local command within the user's utterance frequency data and adjust a predetermined threshold of a confidence score based on the proportion, thereby more accurately determining whether the user's utterance intent corresponds to a global command or a local command.

The technical objects of the present disclosure are not limited to those described above. Other technical objects not mentioned above should be more clearly understood by those having ordinary skill in the art from the description below.

An embodiment of the present disclosure provides a method for understanding an utterance intent using utterance frequency data of a user, the method comprising: checking a screen ID of a previous screen before a user utterance is input; obtaining a number of utterances per screen ID from the utterance frequency data; obtaining a ratio of user utterances intended as a local command from the utterance frequency data when the number of utterances per screen ID is larger than or equal to a predetermined number for all screen ID; and adjusting a threshold of a confidence score based on the ratio.

Another embodiment of the present disclosure provides an apparatus for understanding an utterance intent using utterance frequency data of a user, the apparatus comprising: at least one memory storing instructions; and at least one processor configured execute the instructions, wherein the at least one processor is configured to check a screen ID of a previous screen before a user utterance is input, obtain a number of utterances per screen ID from the utterance frequency data, obtain a ratio of user utterances intended as a local command from the utterance frequency data when the number of utterances per screen ID is larger than or equal to a predetermined number for all screen ID, and adjust a threshold of a confidence score based on the ratio.

According to one embodiment of the present disclosure, a method for understanding a user's utterance intent using the user's utterance frequency data is provided.

According to one embodiment of the present disclosure, the proportion of cases in which a user's utterance intent is a local command within the user's utterance frequency data may be determined. Further, based on the proportion, the threshold of the confidence score may be adjusted, thereby enabling determining of a command relevant to the user's utterance intent.

The technical effects of the present disclosure are not limited to the technical effects described above. Other technical effects not mentioned herein may be more clearly understood by those having ordinary skill in the art to which the present disclosure pertains from the description below.

### BRIEF DESCRIPTION OF THE DRAWINGS

FIG. 1 is a block diagram briefly illustrating a voice recognition-based system according to an embodiment of the present disclosure.

FIG. 2 is a flow diagram illustrating a method for understanding a user's utterance intent using the user's utterance frequency data according to an embodiment of the present disclosure.

FIG. 3A is a figure illustrating an example of increasing the threshold of the confidence score for a global command when the ratio of utterances intended as a local command is larger than or equal to 90% according to an embodiment of the present disclosure.

FIG. 3B is a figure illustrating an example of increasing the threshold of the confidence score for a global command when the ratio of utterances intended as a local command is larger than or equal to 90% according to an embodiment of the present disclosure.

FIG. 3C is a figure illustrating an example of increasing the threshold of the confidence score for a global command when the ratio of utterances intended as a local command is larger than or equal to 90% according to an embodiment of the present disclosure.

FIG. 3D is a figure illustrating an example of increasing the threshold of the confidence score for a global command when the ratio of utterances intended as a local command is larger than or equal to 90% according to an embodiment of the present disclosure.

FIG. 4A is a figure illustrating an example of decreasing the threshold of the confidence score for a global command when the ratio of utterances intended as a local command is less than 90% according to an embodiment of the present disclosure.

FIG. 4B is a figure illustrating an example of decreasing the threshold of the confidence score for a global command when the ratio of utterances intended as a local command is less than 90% according to an embodiment of the present disclosure.

FIG. 4C is a figure illustrating an example of decreasing the threshold of the confidence score for a global command when the ratio of utterances intended as a local command is less than 90% according to an embodiment of the present disclosure.

FIG. 4D is a figure illustrating an example of decreasing the threshold of the confidence score for a global command when the ratio of utterances intended as a local command is less than 90% according to an embodiment of the present disclosure.

FIG. 5 is a block diagram illustrating an example computing device that may be used for implementing a method or an apparatus according to the present disclosure.

Throughout the drawings, the same reference number may be used to refer to the same or similar structure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

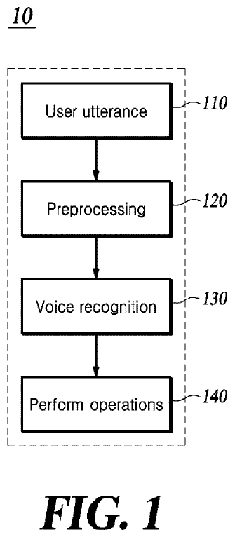

FIG. 1 is a block diagram briefly illustrating a voice recognition-based system according to an embodiment of the present disclosure.

Referring to FIG. 1, when a user's utterance is received, a voice recognition-based system 10 may perform preprocessing on the utterance, perform voice recognition, and perform operations.

The user's utterance 110 generally refers to voice but may also include text. The user's utterance 110 may include the user's question or request.

Preprocessing 120 may extract features from the user's voice and may convert the voice into text. The preprocessing result may be a spectrogram.

Voice recognition 130 may refer to identifying the intent of the user's utterance. Traditionally, an acoustic model (AM), a language model (LM), and a pronunciation dictionary (lexicon) are used for voice recognition 130. When using a traditional voice recognition method, separate modules may be used for preprocessing and voice recognition.

When using a voice recognition method using an End-to-End (E2E) voice recognition model, preprocessing 120 and voice recognition 130 may be performed using a single module. Therefore, the preprocessing 120 and voice recognition 130 steps may not be clearly distinguished from each other.

In the present disclosure, the acoustic model, language model, and pronunciation dictionary are not separately distinguished, and the entity that performs voice recognition is collectively referred to as a ‘voice recognition model.’

For preprocessing 120 or speech recognition 130, Natural Language Understanding (NLU) or Natural Language Processing (NLP) may be used.

The step of performing operations 140 may be performing operations corresponding to a command. The operations corresponding to a command may be the operations performed as an information provision system, such as providing a response that matches the intent of the user's utterance, accessing a database and searching for information to provide a response that matches the intent of the user's utterance, and performing conversion into a format suitable for the Audio Video Navigation Telematics (AVNT) scenario for providing the response. In addition, the operations corresponding to the command may include operations performed as a vehicle control system, such as adjusting the indoor environment (e.g., the vehicle temperature) or adjusting driving parameters related to the vehicle's speed and steering.

The method for understanding a user's utterance intent using the user's utterance frequency data according to an embodiment of the present disclosure may correspond to the voice recognition 130 of the voice recognition-based system 10.

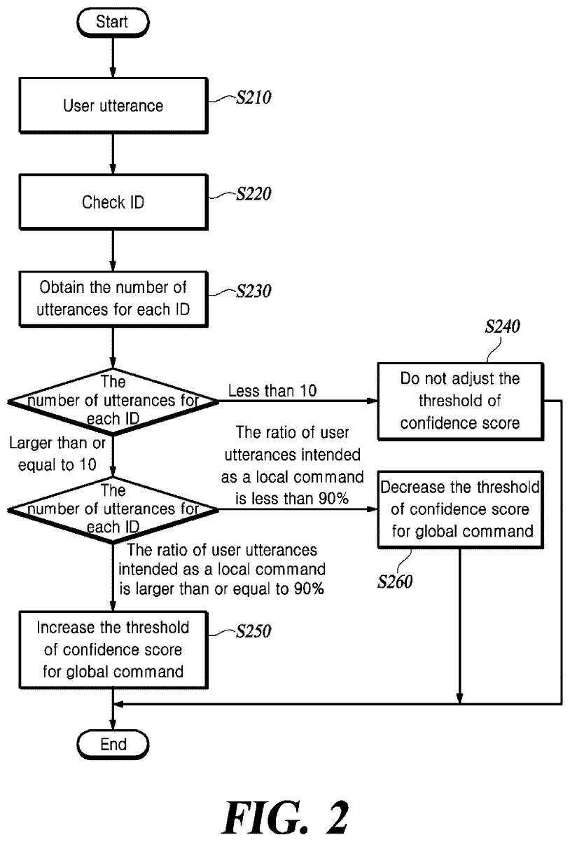

FIG. 2 is a flow diagram illustrating a method for understanding a user's utterance intent using the user's utterance frequency data according to an embodiment of the present disclosure. The process of FIG. 2 may be performed by a voice recognition model.

In an operation S210, the voice recognition model receives the user's utterance. The user's utterance generally refers to voice but may also include text in some cases. The user's utterance may include the user's question or request.

In an operation S220, when an utterance is received, the voice recognition model may check the ID (screen ID) of a previous screen before the utterance is input. The previous screen may include various screens such as a navigation screen, a song search results screen, and/or a system basic screen.

In an operation S230, when the ID check is completed, the voice recognition model may obtain the number of user utterances for each ID. The number of user utterances for each ID may be obtained by loading the user's utterances from a storage such as a database and having the voice recognition model calculate the number of utterances of the user for each ID. Alternatively, the number of user utterances for each ID may be obtained by retrieving the number of user utterances for each ID calculated in advance. The number of user utterances for each ID may be interpreted as the user's utterance frequency data.

If the number of utterances for each ID is less than a predetermined number, for example, less than 10, in an operation S240, the voice recognition model does not adjust a threshold of a confidence score (sometimes referred to herein as “confidence score threshold”). The voice recognition model may determine a command based on a predetermined threshold of the confidence score and may collect data related to the user utterances to accumulate a sufficient amount of utterance frequency data. The data related to the user utterance may include the content of a user utterance and a previous screen before the user utterance is input.

If the number of utterances for an ID exceeds a predetermined number, for example, larger than or equal to 10, the voice recognition model obtains the ratio of the user utterances intended as a local command for the corresponding ID. The ratio of utterances may be the proportion of particular (e.g., local) commands to all commands executed by the voice recognition mode for the specific ID. The ratio of the user utterance intent as a local command may be obtained by retrieving user utterances, IDs, and commands selected at the time of user utterances from the database and calculating the proportion of local commands to the entirety of commands executed by the voice recognition mode for the specific ID, similarly to the case of calculating the number of utterances for each ID. Alternatively, the ratio may be obtained by retrieving a pre-calculated ratio.

A local command is a command whose recognition or operation is limited depending on a previous screen before a user utterance is input. For example, suppose the screen before the user utterance is input is a song search results screen, and the user utterance is “Yanghwa Bridge.” If the user's intent is interpreted as a local command, recognition or operation is limited to operations related to songs, for example, “searching for the song Yanghwa Bridge” or “playing the song Yanghwa Bridge.”

For example, when the voice recognition model according to an embodiment of the present disclosure is a voice recognition model mounted on or linked to a vehicle, the local command may be i) ‘Local_music_song’ which causes a music play system of the vehicle to search for/play a song corresponding to the user utterance, ii) ‘Local_music_album’ which causes the music play system of the vehicle to search for an album corresponding to the user utterance, or iii) ‘Local_music_singer’ which causes the music play system of the vehicle to search for a singer corresponding to the user utterance.

A global command is a command that is recognized or performs an operation regardless of the previous screen before the user utterance is input. For example, if the user utterance is “Yanghwa Bridge,” and the intent of the utterance is interpreted as a global command while the previous screen before the user utterance is input is the song search results screen, since Yanghwa Bridge generally refers to a specific place, recognition or operation is performed by interpreting the user utterance as ‘search for Yanghwa Bridge’ in the context of place search.

For example, when the voice recognition model according to an embodiment of the present disclosure is a voice recognition model mounted on or linked to a vehicle, the global command may be i) ‘Global poi_destination’ which causes the vehicle's navigation system to select a location corresponding to the user utterance as a destination or ii) ‘Global_poi_stopover’ which causes the vehicle's navigation system to add a place corresponding to the user utterance as a waypoint.

In an operation S250, when the proportion of cases where the intent of the user's utterance is a local command is larger than or equal to, for example, 90%, the voice recognition model increases the threshold of the confidence score for the global command.

In an operation S260, when the proportion of cases where the intent of the user's utterance is a local command is less than, for example, 90%, the voice recognition model decreases the threshold of the confidence score for the global command.

The confidence score is a measure indicating the reliability of voice recognition results. The confidence score may be calculated by a voice recognition model. For example, the confidence score may be defined as the likelihood that a recognized phoneme or word is correct, relative to the probability that the utterance originates from another phoneme or word. The confidence score may be expressed as a value between 0 and 1, or as a value between 0 and 10,000, which is not limited to the specific value.

The threshold of the confidence score may be a criterion used to determine a command corresponding to the intent of the user utterance among at least one command candidate included in the voice recognition result. A specific command candidate may be determined as the command corresponding to the intent of the user utterance, when the confidence score of the specific command candidate is greater than or equal to the threshold of confidence score for the specific command candidate.

The confidence score threshold may be set to an initial value. If the number of user utterances with a specific ID is less than a predetermined number, for example, less than 10, the threshold of the confidence score may be maintained at a predetermined initial value. If the number of user utterances with a specific ID is larger than of equal to 10, the threshold of the confidence score may be adjusted based on the user's utterance frequency data. The threshold of the confidence score may vary for each command.

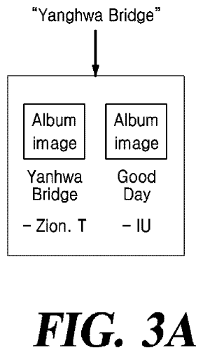

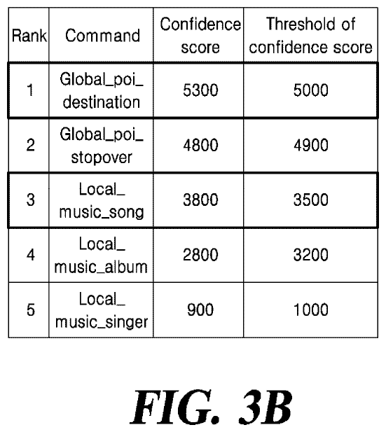

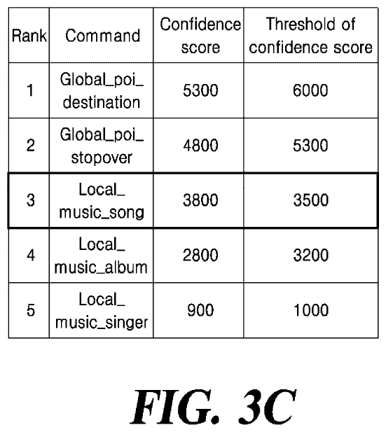

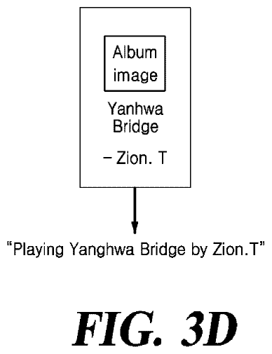

FIGS. 3A, 3B, 3C and 3D are figures illustrating an example of increasing the threshold of the confidence score for a global command when the ratio of utterances intended as a local command is larger than or equal to 90% according to an embodiment of the present disclosure.

The previous screen before a user utterance is input is the song search results screen. The user utterance is “Yanghwa Bridge” and is a voice. FIG. 3A shows a case where a user utterance is received on the previous screen before the user utterance is input.

The voice recognition model may search for command candidates and may obtain a confidence score for each command candidate. FIG. 3B shows command candidates and their confidence scores.

The voice recognition model may check the screen ID before an utterance is input. An ID corresponding to the screen shown in FIG. 3A is obtained.

The voice recognition model may obtain the number of user utterances for each ID. In the illustrated embodiment, the number of utterances made by the user on the screen shown in FIG. 3A is 20.

Since the number of utterances for each ID is larger than or equal to 10, the voice recognition model obtains the ratio at which the intent of user utterance is a local command for the corresponding ID. In the illustrated embodiment, the user utterance made on the screen of FIG. 3A is understood to be intended as a local command 18 times. Therefore, the ratio of utterances intended as local command is 90%.

Since the ratio is larger than or equal to 90%, the voice recognition model adjusts the threshold of the confidence score for global commands to increase. Among the command candidates, FIG. 3B and FIG. 3C show two examples of global commands: ‘Global_poi_destination’ and ‘Global_poi_stopover.’ Therefore, the threshold of the confidence score for ‘Global_poi_destination’ is increased from 5,000 to 6,000, and the threshold of the confidence score for ‘Global_poi_stopover’ is increased from 4,900 to 5,300. The extent to which the threshold is increased may vary for each command. FIG. 3B shows the existing threshold, and FIG. 3C shows the increased threshold. The voice recognition model increases the threshold of the confidence score for global commands when the ratio of utterances intended as a local command is larger than or equal to 90%, so that it makes more difficult for global commands to be selected, and accordingly makes easier for local commands to be selected, among the command candidates.

The voice recognition model may determine a command that matches the intent of a user utterance by listing command candidates in order of confidence scores and selecting those higher than or equal to a threshold. Based on the existing threshold, in FIG. 3B, ‘Global_poi_destination’ and ‘Local_music_song’ may be determined as commands that match the intent of the user utterance. Based on the adjusted threshold, however, in FIG. 3C, ‘Local_music_song’ may be determined as a command that matches the intent of the user utterance.

The voice recognition model may determine ‘Local_music_song’ as a command based on the adjusted threshold. Based on the user's utterance frequency data, since the ratio of the user utterances intended as a local command is 90% or higher, it is reasonable to execute a local command rather than a global command on the screen shown in FIG. 3A.

If the voice recognition model is mounted on or linked to a vehicle, executing the ‘Local_music_song’ command may cause the vehicle's music play system to search for/play the “Yanghwa Bridge” song. FIG. 3D shows the vehicle's music play system playing the song “Yanghwa Bridge.” To execute the command, the voice recognition model may provide the command ‘Local_music_song’ as an input to the vehicle's control device.

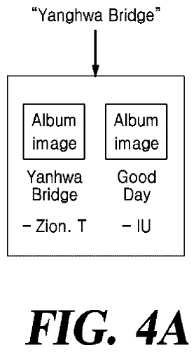

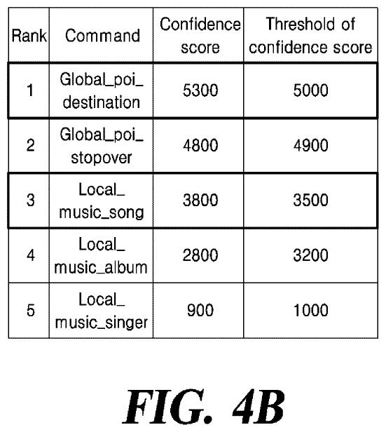

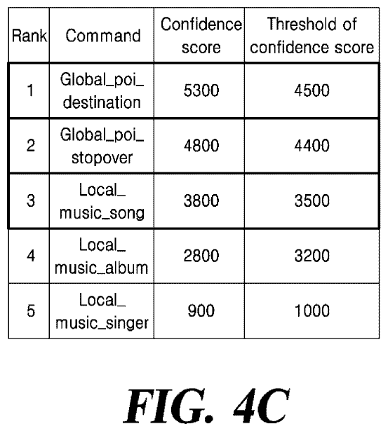

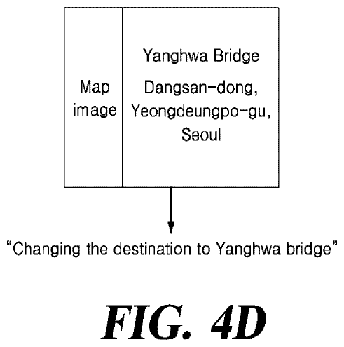

FIGS. 4A, 4B, 4C and 4D are figures illustrating an example of decreasing the threshold of the confidence score for a global command when the ratio of utterances intended as a local command is less than 90% according to an embodiment of the present disclosure.

The previous screen before a user utterance is input is the song search results screen. The user utterance is “Yanghwa Bridge” and is a voice. FIG. 4A shows a case where a user utterance is received on the previous screen before the user utterance is input.

The voice recognition model may search for command candidates and obtain a confidence score for each command candidate. FIG. 4B shows command candidates and their confidence scores.

The voice recognition model may check the screen ID before an utterance is input. An ID corresponding to the screen shown in FIG. 4A is obtained.

The voice recognition model may obtain the number of user utterances for each ID. In the illustrated embodiment, the number of utterances made by the user on the screen shown in FIG. 4A is 20.

Since the number of utterances for each ID is larger than or equal to 10, the voice recognition model obtains the ratio at which the intent of user utterance is a local command for the corresponding ID. In the illustrated embodiment, the user utterance made on the screen of FIG. 4A is understood to be intended as a local command 18 times. Therefore, the ratio of utterances intended as local command is 50%.

Since the ratio is less than 90%, the voice recognition model adjusts the threshold of the confidence score for global commands to decrease. Among the command candidates, FIG. 4B and FIG. 4C show two examples of global commands: ‘Global_poi_destination’ and ‘Global poi_stopover.’ Therefore, the threshold of ‘Global poi_destination’ is decreased from 5,000 to 4,500, and the threshold of ‘Global_poi_stopover’ is decreased from 4,900 to 4,400. The extent to which the threshold is decreased may vary for each command. FIG. 4B shows the existing threshold, and FIG. 4C shows the decreased threshold. The voice recognition model decreases the threshold of confidence score for global commands when the ratio of utterances intended as a local command is less than 90%, so that it makes easier for global commands to be selected, and accordingly makes more difficult for local commands to be selected, among the command candidates.

The voice recognition model may determine a command that matches the intent of a user utterance by listing command candidates in order of confidence scores and then selecting those higher than a threshold. Based on the existing threshold, in FIG. 4B, ‘Global_poi_destination’ and ‘Local_music_song’ may be determined as commands that match the intent of the user utterance. Based on the adjusted threshold, however, in FIG. 4C, ‘Global poi_destination,’ ‘Global poi_stopover,’ and ‘Local_music_song’ may be determined as commands that match the intent of the user utterance.

The voice recognition model may determine ‘Global_poi_destination’ as a command based on the adjusted threshold. If there are multiple command candidates with confidence scores greater than or equal to the threshold, different criteria may be employed for determining commands for each voice recognition model. Since the voice recognition model according to an embodiment of the present disclosure determines the command with the highest confidence score among those exceeding the threshold, ‘Global_poi_destination’ is determined as the command.

If the voice recognition model is mounted on or linked to a vehicle, executing the ‘Global_poi_destination’ command may cause the vehicle's navigation system to set the place corresponding to the user utterance as a destination. FIG. 4D illustrates that the vehicle's navigation system sets “Yanghwa Bridge” as the destination. To execute the command, voice recognition model may provide the command ‘Global_poi_destination’ as an input to the vehicle's control device.

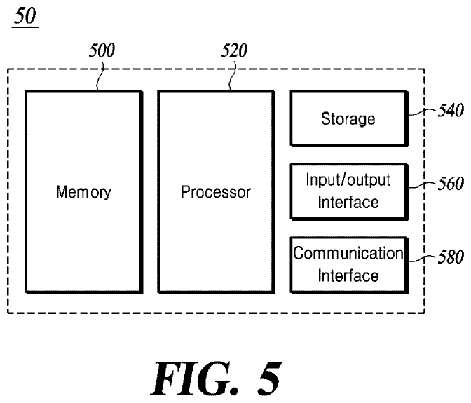

FIG. 5 is a block diagram illustrating an example computing device that may be used for implementing a method or an apparatus according to embodiments of the present disclosure.

The computing device 50 may include all or part of a memory 500, a processor 520, a storage 540, an input/output interface 560, and a communication interface 580. The computing device 50 may be a stationary computing device, such as a desktop computer or a server, or a mobile computing device, such as a laptop computer or a smart phone. The computing device 50 may include a specialized hardware accelerator capable of processing operations of an artificial intelligence model in an efficient manner. For example, the computing device 50 may include a graphic processing unit (GPU), a tensor processing unit (TPU), or a neural processing unit (NPU).

The memory 500 may store a program that enables the processor 520 to perform methods or operations according to various embodiments of the present disclosure. For example, a program may include a plurality of computer-readable instructions executable by the processor 520, and the methods or operations described above may be performed by executing the plurality of computer-readable instructions by the processor 520. The memory 500 may consist of a single memory or a plurality of memories. In this case, information required to perform the methods or operation according to various embodiments of the present disclosure may be stored in a single memory or distributed across a plurality of memories. When the memory 500 is composed of a plurality of memories, the plurality of memories may be physically separated. The memory 500 may include at least one of volatile memory and non-volatile memory. Volatile memory includes Static Random Access Memory (SRAM) or Dynamic Random Access Memory (DRAM), while non-volatile memory includes flash memory.

The processor 520 may include at least one core capable of executing at least one instruction. The processor 520 may execute instructions stored in the memory 500. The processor 520 may consist of a single processor or a plurality of processors.

The storage 540 maintains stored data even if power supplied to the computing device 50 is cut off. For example, the storage 540 may include non-volatile memory or may include a storage medium such as a magnetic tape, an optical disk, or a magnetic disk. A program stored in the storage 540 may be loaded into the memory 500 before being executed by the processor 520. The storage 540 may store files written in a program language, and a program created from the files by a compiler may be loaded into the memory 500. The storage 540 may store data to be processed by the processor 520 and/or data processed by the processor 520.

The input/output interface 560 may provide an interface with an input device such as a keyboard or a mouse and/or an output device such as a display device or a printer. The user may trigger execution of a program by the processor 520 through the input device and/or check the processing results of the processor 520 through the output device.

The communication interface 580 may provide access to an external network. The computing device 50 may communicate with other devices through the communication interface 580.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method for understanding an utterance intent using utterance frequency data of a user, the method comprising:
checking a screen ID of a previous screen before a user utterance is input;
obtaining a number of utterances per screen ID from the utterance frequency data;
obtaining a ratio of user utterances intended as a local command from the utterance frequency data when the number of utterances per screen ID is larger than or equal to a predetermined number for all screen ID; and
adjusting a threshold of a confidence score based on the ratio.

2. The method of claim 1, further comprising:
searching for at least one command candidate corresponding to the user utterance;
obtaining a confidence score for each of the at least one command candidate; and
determining a command by selecting a command candidate for which the confidence score is larger than or equal to the threshold of the confidence score.

3. The method of claim 2, wherein the threshold of the confidence score is set differently for each command candidate.

4. The method of claim 1, wherein adjusting the threshold of the confidence score includes, when the ratio is larger than or equal to 90%, adjusting the threshold of the confidence score for a global command to increase.

5. The method of claim 1, wherein adjusting the threshold of the confidence score includes, when the ratio is less than 90%, adjusting the threshold of the confidence score for a global command to decrease.

6. The method of claim 1, further comprising, when any of the screen ID has the number of utterances less than the predetermined number, not adjusting the threshold of the confidence score.

7. An apparatus for understanding an utterance intent using utterance frequency data of a user, the apparatus comprising:
at least one memory storing instructions; and
at least one processor configured execute the instructions, wherein the at least one processor is configured to
check a screen ID of a previous screen before a user utterance is input,
obtain a number of utterances per screen ID from the utterance frequency data,
obtain a ratio of user utterances intended as a local command from the utterance frequency data when the number of utterances per screen ID is larger than or equal to a predetermined number for all screen ID, and
adjust a threshold of a confidence score based on the ratio.

8. The apparatus of claim 7, wherein the processor is further configured to:
search for at least one command candidate corresponding to the user utterance;
obtain a confidence score for each of the at least one command candidate; and
determine a command by selecting a command candidate for which the confidence score is larger than or equal to the threshold of the confidence score.

9. The apparatus of claim 8, wherein the threshold of the confidence score is set differently for each command candidate.

10. The apparatus of claim 7, wherein the processor is configured to, when the ratio is larger than or equal to 90%, adjust the threshold of the confidence score for a global command to increase.

11. The apparatus of claim 7, wherein the processor is configured to, when the ratio is less than 90%, adjust the threshold of the confidence score for a global command to decrease.

12. The apparatus of claim 7, wherein the processor is configured to, when any of the screen ID has the number of utterances less than the predetermined number, not adjust the threshold of the confidence score.
